(19) United States
(12) Patent Application Publication
(10) Pub. No.: US 2004/0035245 A1
(43) Pub. Date: Feb. 26, 2004

(54) Plastic control plate of a hydraulic gearbox control device in a motor vehicle

(76) Inventors: Roland Albert, Regensburg (DE); Christian Fritzsche, Regensburg (DE); Andreas Rekofsky, Mintraching (DE); Ulf Scheuerer, Hagelstadt (DE)

Correspondence Address: Baker Botts L.L.P., 910 Louisiana Street, Houston, TX, 77002-4995, US

(21) Appl. No.: 10/616,018

(22) Filed: Jul. 9, 2003

Related U.S. Application Data
(63) Continuation of application No. PCT/DE02/00044, filed on Jan. 9, 2002.

(30) Foreign Application Priority Data
Jan. 11, 2001 (DE) 10101091.5
Sep. 27, 2001 (DE) 20115922.8

(51) Int. Cl. B60K 20/00

(52) U.S. Cl. 74/606 A

(57) ABSTRACT

A plastic control plate for a gearbox control device of a hydraulic motor vehicle is disclosed, which comprises at least one channel (2a, 2b, 2c, 2d, 2e, 2f, 2′) extending in the plastic control plate (1) and is used to guide a cooling medium and a heat conducting body (3) which is at least partially integrated into the plastic control plate (1) and is arranged directly adjacent to the channel (2a, 2b, 2c, 2d, 2e, 2f, 2′).

### CROSS REFERENCE TO RELATED APPLICATION

This application is a continuation of copending International Application No. PCT/DE02/00044 filed Jan. 9, 2002 and claiming a priority date of Jan. 11, 2001, which designates the United States.

### TECHNICAL FIELD OF THE INVENTION

The invention relates to a plastic control plate of a hydraulic gearbox control device in a motor vehicle.

### BACKGROUND OF THE INVENTION

Mechanical control of the gearbox is achieved by means of a hydraulic gearbox control device which carries out the pressure increase, the volume flow increase, and the distribution of the hydraulic fluid. In order to ensure the distribution of the hydraulic fluid, the hydraulic gearbox control device has one or more metal plates (control plate, channel plate), in which channels for hydraulic fluid are formed.

In motor vehicle construction, increasing effort is being made to achieve a compact construction of all types of components of a motor vehicle. Increasing use is therefore being made of integrated electronic-hydraulic gearbox controls in motor vehicle gearboxes. For example, in the case of a design which is summarized by the term “local electronics”, a control electronics system for the hydraulic control device is arranged within the gearbox, thereby creating an integrated gearbox control. In this case, the metal plates of the gearbox control device are used for attaching electrical components such as sensors or actuators, for example solenoid valves, or even the control electronics system, onto said gearbox control device. An adequate heat dissipation of the heat produced in these components must be ensured.

### SUMMARY OF THE INVENTION

The invention addresses the problem of providing a control plate for a hydraulic gearbox control device in a motor vehicle, which control plate is inexpensive to manufacture and allows adequate heat dissipation for the heat-generating components. In particular, a compact implementation of the control plate should be possible.

This object can be achieved by a plastic control plate of a hydraulic gearbox control device in a motor vehicle, comprising at least one channel which runs through the plastic control plate and is used for carrying a cooling medium, and a heat conduction body which is at least partly integrated in the plastic control plate and is arranged directly adjacent to the channel.

The object can also be achieved by an arrangement comprising a plastic control plate and a gearbox control electronics system, wherein the plastic control plate comprises: at least one channel which runs through the plastic control plate and is used for carrying a cooling medium, and a heat conduction body which is at least partly integrated in the plastic control plate and is arranged directly adjacent to the channel. The gearbox control electronics system, in particular a substrate carrying the electronic components of said system, is arranged directly on the upper surface of the heat conduction body.

The object can further be achieved by a gearbox control system comprising a plastic control plate, at least one channel which runs through the plastic control plate for carrying a cooling medium, a heat conduction body which is at least partly integrated in the plastic control plate and is arranged directly adjacent to the channel, and a gearbox control circuit arranged on a substrate which is arranged directly on the upper surface of the heat conduction body.

The gearbox control electronics system or circuit may be electrically contacted via an electrical circuit board, in particular a flexible circuit board. The gearbox control electronics system or circuit may also be electrically contacted via a stamped-grid arrangement, which extends partly over the upper surface of the plastic control plate and partly over the upper surface of the heat conduction body. The heat conduction body can be a metal plate, in particular an aluminum plate. The heat conduction body can be designed in such a way that the cooling medium, in particular a hydraulic fluid, flows against it. A flat area of the heat conduction body can be designed as a wall area of the channel. The heat conduction body can be designed in the form of a U, wherein the inner sides of the U form wall areas of the channel. The upper surface of the plastic control plate can be flush with the upper surface of the heat conduction body.

The basis of the invention is a control plate made of plastic, said control plate being arranged in a hydraulic gearbox control device in a motor vehicle. At least one channel for carrying a cooling medium, in particular a hydraulic fluid, extends within the plastic control plate. The idea on which the invention is based consists of designing the plastic control plate in such a way that an adequate heat dissipation is ensured. In addition to the channel, a heat conduction body is at least partly integrated in the plastic control plate, thus forming a heat sink in the plastic control plate. Since the heat conduction body is arranged directly adjacent to the channel, an effective heat dissipation is ensured. As a result of integrating the heat conduction body into the plastic control plate, said plastic control plate also has a compact construction.

The heat conduction body is advantageously designed as a metal plate, in particular as an aluminum plate.

A further advantageous configuration of the invention provides for arranging the heat conduction body and the channel relative to each other in such a way that the cooling medium carried in the channel flows against the heat conduction body. This can be structurally implemented such that a surface area of the heat conduction body is designed to form at least one wall area of the channel.

Because the heat conduction body is integrated into the plastic control plate in such a way that the upper surface of the control plate is flush with the upper surface of the heat conduction body, the control plate can be manufactured to be plane and without additional space being required for the heat conduction body. In particular, the heat conduction body can also be designed in the form of an inverted U.

A gearbox control electronics system which generates heat during operation, in particular a substrate carrying the electronic components of said system, is advantageously arranged directly on the surface of the heat conduction body. This can ensure an adequate heat loss dissipation of the electronic components and reliably prevent any damage or destruction of the gearbox control electronics system as a result of overheating.

### BRIEF DESCRIPTION OF THE DRAWINGS

The invention is described below using exemplary embodiments and with reference to the drawings, in which:

FIG. 1 shows a cross-section through a first exemplary embodiment of the plastic control plate in accordance with the invention;

FIG. 2 shows a schematic diagram of a top view of the arrangement as per FIG. 1;

FIG. 3 shows a cross-section through a second exemplary embodiment of the plastic control plate;

FIG. 4 shows a schematic diagram of the top view of the arrangement as per FIG. 3;

FIG. 5 shows a cross-section through a third exemplary embodiment of the plastic control plate.

### DETAILED DESCRIPTION OF THE PREFERRED EMBODIMENTS

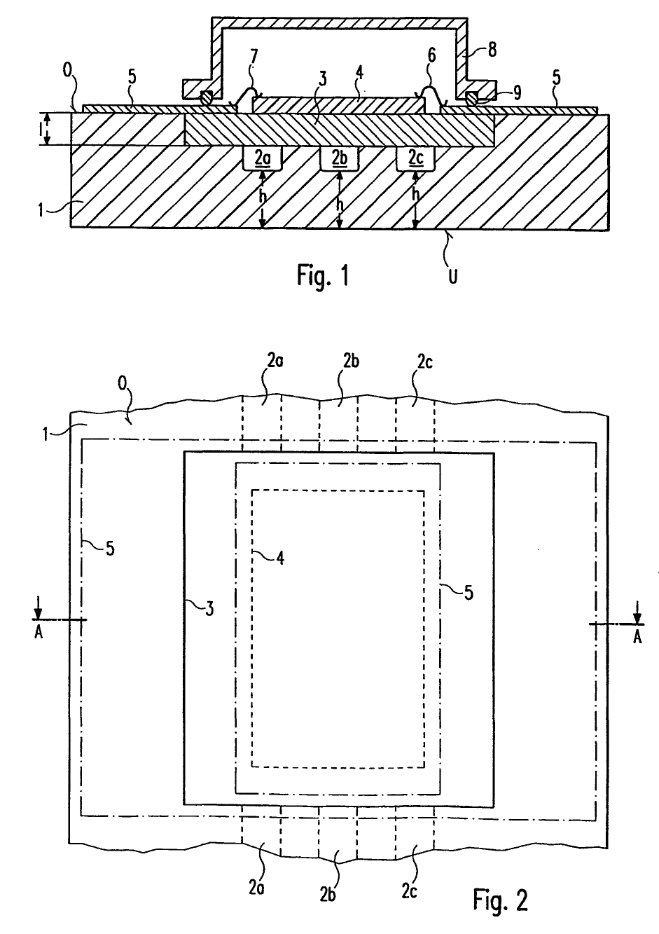

A plastic control plate 1 (FIG. 1) is designed as an injection-molded plastic body and forms a part of a hydraulic control housing of a hydraulic gearbox control device in a motor vehicle. The hydraulic motor-vehicle gearbox control device is attached, for example, in the lower section of the gearbox housing, such that it lies within the oil sump.

The plastic control plate 1 has three channels 2a, 2b and 2c. The channels 2a, 2b and 2c in the exemplary embodiment all have the same cross-section and are designed within, and separated by a distance of h from the underside U of, the plastic control plate 1. In each case, three sides of the rectangular channels 2a, 2b and 2c are directly delimited by the plastic control plate 1. A heat conduction body 3 which is configured in the exemplary embodiment as a single metal plate, in particular as an aluminum plate, is integrated into the plastic control plate 1.

The heat conduction body 3 has a constant thickness 1 and is arranged above the channels 2a, 2b and 2c. Surface areas on the underside of the heat conduction body 3 form one of the four wall areas on each of the rectangular channels 2a, 2b and 2c in each case. Consequently, the cooling medium flowing through the channels 2a, 2b and 2c flows directly against the heat conduction body 3. The heat conduction body 3 is integrated into the plastic control plate 1 and its upper surface is flush with the upper surface O of the plastic control plate 1.

A gearbox control electronics system in the form of a circuit board 4 carrying the electronic components (not shown) is arranged on the heat conduction body 3 which is integrated into the plastic control plate 1. The circuit board 4 is preferably arranged such that its entire lower surface lies directly on the heat conduction body 3 and is bonded onto said heat conduction body by means of a heat-conductive adhesive.

A further circuit board 5, for example in the form of a flexible circuit board, is arranged partly on the upper surface O of the plastic control plate 1 and partly on the heat conduction body 3. The circuit board 5 contacts to the circuit board 4, which carries the electronic components, via bond wires 6 and 7. It is also possible to implement the circuit board 5 as a stamped grid, which is injected or cast onto the plastic control plate 1.

In order to protect the electronic components of the gearbox control circuit, which are arranged on the circuit board 4, from the surrounding medium (oil), a cover 8 is arranged over the circuit board 4. The cover 8 is located over a sealing ring 9 on the circuit board 5 and forms an oil-proof housing space for the gearbox control electronics system.

The cover 8, which is made of metal or plastic, can be fixed by means of rivets, screws, compression-pin connections, or similar means.

FIG. 2 shows a schematic diagram of a top view of the arrangement described in FIG. 1. The illustration as per FIG. 1 shows a cross-section with reference to the sectional line AA. In accordance with FIG. 2, the circuit board 4 is arranged with its surface entirely on the heat conduction body 3. The circuit board 5, which is illustrated by contour lines, is arranged separately from the circuit board 4 on the heat conduction body 3 and the upper surface O of the plastic control plate 1, and completely surrounds the circuit board 4 on the upper surface of the heat conduction body 3. The channels 2a, 2b and 2c, illustrated by their boundary lines, run parallel with each other in the exemplary embodiment. However, the course of the channels 2a, 2b and 2c in the plastic control plate 1 can be designed in a multiplicity of ways.

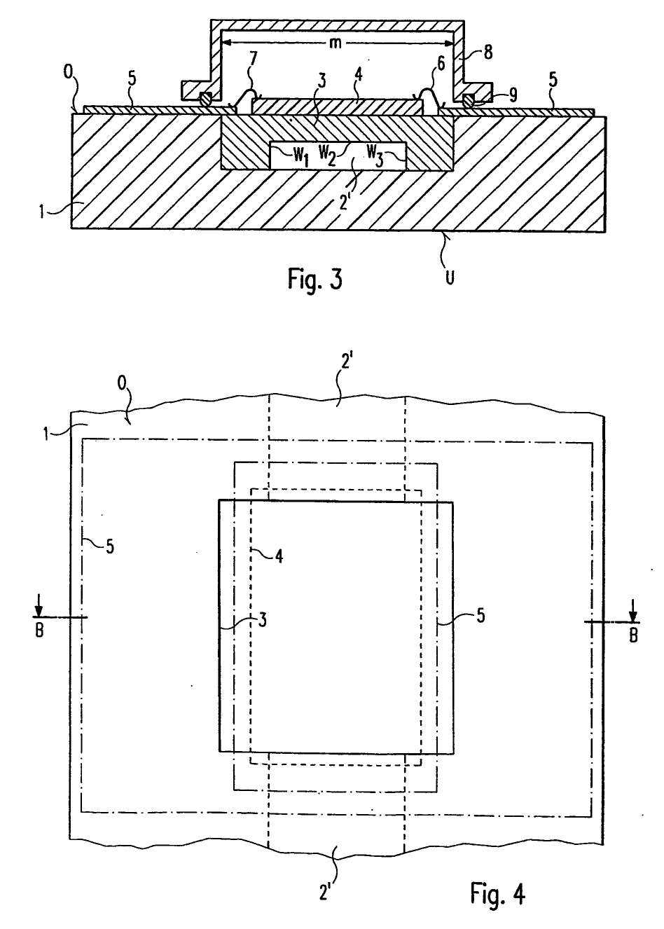

In a second exemplary embodiment in accordance with FIG. 3, identical or functionally identical components are assigned the same reference characters. The heat conduction body 3 is designed as a single, U-shaped aluminum plate. The cooling medium which flows in the channel 2′ flows against the heat conduction body 3 at three wall areas W₁, W₂ and W₃ of the channel 2′. As a result of geometrically structuring the heat conduction body 3 and the channel 2′ in this way, the heat generated during operation of the control electronics system arranged on the circuit board 4 is dissipated particularly effectively. The heat conduction body 3 has a width which corresponds to an inner wall width m of the cover 8, and is therefore designed to be smaller than the heat conduction body 3 in the FIGS. 1 and 2.

FIG. 4 shows a schematic diagram of the top view of the arrangement as per FIG. 3. FIG. 3 illustrates a cross-section along the sectional line BB. The heat conduction body 3, which is illustrated by its contour lines, is designed in such a way that the lower surface of the circuit board 4 is arranged only partly on the upper surface of the heat conduction body 3 which is flush with the upper surface O of the plastic control plate 1.

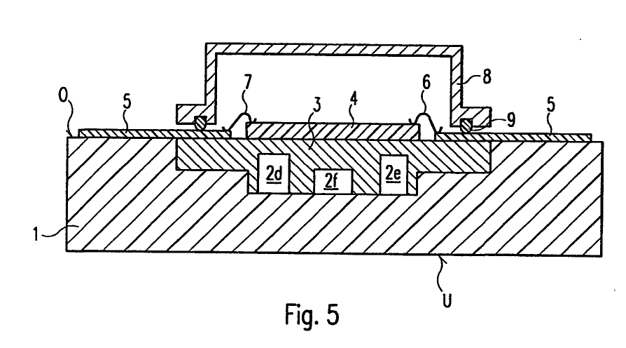

The exemplary embodiment as per FIG. 5 illustrates a further possible geometric structure of the heat conduction body 3 and of channels 2d, 2e and 2f. The heat conduction body 3 is thicker in the area below the circuit board 4 than in the areas which are not arranged vertically below the circuit board 4. The channels 2d and 2e have a different cross-section to that of channel 2f. The other reference characters correspond to identical or functionally identical components of the exemplary embodiments described above.

The top view for FIG. 5 corresponds to that shown in FIG. 4.

In all the exemplary embodiments, it is also possible for the heat conduction body 3 to be only partly integrated into the plastic control plate 1, and for the upper surface O of the plastic control plate 1 and the upper surface of the heat conduction body 3 not to be flush.

The heat conduction body 3 can be incorporated into a correspondingly shaped void in the plastic control plate 1 by means of injecting, casting or gluing.

The channels in the respective exemplary embodiments can be designed in a multiplicity of ways and be connected to each other, for example by means of transverse channels or similar means.

Both the circuit board 4 and the circuit board 5 can be attached onto the upper surface O of the plastic control plate 1 and the upper surface of the heat conduction body 3 by means of lamination or adhesion.

The design of the geometries of the heat conduction body 3 and the channels 2a, 2b, 2c, 2d, 2e, 2f and 2′ are not restricted by the possibilities illustrated in the figures. The geometry of the heat conduction body 3 can therefore have the form of a cuboid or a cylinder, for example, and the channels can have a circular or polygonal cross-section, for example, and e.g. a toroidal geometry.

1. A plastic control plate of a hydraulic gearbox control device in a motor vehicle, comprising
at least one channel which runs through the plastic control plate and is used for carrying a cooling medium, and
a heat conduction body which is at least partly integrated in the plastic control plate and is arranged directly adjacent to the channel.

2. The plastic control plate as claimed in claim 1, wherein the heat conduction body is a metal plate, in particular an aluminum plate.

3. The plastic control plate as claimed in claim 1, wherein the heat conduction body is designed in such a way that the cooling medium, in particular a hydraulic fluid, flows against it.

4. The plastic control plate as claimed in claim 1, wherein a flat area of the heat conduction body is designed as a wall area of the channel.

5. The plastic control plate as claimed in claim 1, wherein the heat conduction body is designed in the form of a U, wherein the inner sides of the U form wall areas of the channel.

6. The plastic control plate as claimed in claim 1, wherein the upper surface of the plastic control plate is flush with the upper surface of the heat conduction body.

7. An arrangement comprising a plastic control plate and a gearbox control electronics system, wherein the plastic control plate comprises:
at least one channel which runs through the plastic control plate and is used for carrying a cooling medium, and
a heat conduction body which is at least partly integrated in the plastic control plate and is arranged directly adjacent to the channel, and wherein the gearbox control electronics system, in particular a substrate carrying the electronic components of said system, is arranged directly on the upper surface of the heat conduction body.

8. The arrangement as claimed in claim 7, wherein the gearbox control electronics system is electrically contacted via an electrical circuit board, in particular a flexible circuit board.

9. The arrangement as claimed in claim 7, wherein the gearbox control electronics system is electrically contacted via a stamped-grid arrangement, which extends partly over the upper surface of the plastic control plate and partly over the upper surface of the heat conduction body.

10. The arrangement as claimed in claim 7, wherein the heat conduction body is a metal plate, in particular an aluminum plate.

11. The arrangement as claimed in claim 7, wherein the heat conduction body is designed in such a way that the cooling medium, in particular a hydraulic fluid, flows against it.

12. The arrangement as claimed in claim 7, wherein a flat area of the heat conduction body is designed as a wall area of the channel.

13. The arrangement as claimed in claim 7, wherein the heat conduction body is designed in the form of a U, wherein the inner sides of the U form wall areas of the channel.

14. The arrangement as claimed in claim 7, wherein the upper surface of the plastic control plate is flush with the upper surface of the heat conduction body.

15. A gearbox control system comprising:
a plastic control plate
at least one channel which runs through the plastic control plate for carrying a cooling medium,
a heat conduction body which is at least partly integrated in the plastic control plate and is arranged directly adjacent to the channel,
a gearbox control circuit arranged on a substrate which is arranged directly on the upper surface of the heat conduction body.

16. The gearbox control system as in claim 15, wherein the gearbox control circuit is electrically contacted via an electrical circuit board, in particular a flexible circuit board.

17. The gearbox control system as in claim 15, wherein the gearbox control system is electrically contacted via a stamped-grid arrangement, which extends partly over the upper surface of the plastic control plate and partly over the upper surface of the heat conduction body.

18. The gearbox control system as in claim 15, wherein the heat conduction body is a metal plate, in particular an aluminum plate.

19. The gearbox control system as in claim 15, wherein the heat conduction body is designed in such a way that the cooling medium, in particular a hydraulic fluid, flows against it.

20. The gearbox control system as in claim 15, wherein a flat area of the heat conduction body is designed as a wall area of the channel.

21. The gearbox control system as in claim 15, wherein the heat conduction body is designed in the form of a U, wherein the inner sides of the U form wall areas of the channel.

22. The gearbox control system as in claim 15, wherein the upper surface of the plastic control plate is flush with the upper surface of the heat conduction body.
